(19) United States
(12) Patent Application Publication
(10) Pub. No.: US 2021/0405987 A1
(43) Pub. Date: Dec. 30, 2021

(54) DYNAMIC DRIVER SELECTION BASED ON FIRMWARE FOR A HARDWARE COMPONENT

(71) Applicant: LENOVO Enterprise Solutions (Singapore) PTE. LTD., New Tech Park (SG)

(72) Inventors: Fred A. Bower, III, Durham, NC (US); Andrew J. Sloma, Austin, TX (US); Caihong Zhang, Shanghai (CN); Da Ke Xu, Shanghai (CN); Jarrod B. Johnson, Raleigh, NC (US)

(21) Appl. No.: 16/917,224

(22) Filed: Jun. 30, 2020

(51) Int. Cl. G06F 8/61; G06F 9/455

(52) U.S. Cl. CPC G06F 8/61; G06F 9/4411; G06F 2009/45562; G06F 9/45558

(57) ABSTRACT

An apparatus for dynamic driver selection based on firmware for a hardware component includes a processor and a memory that stores program code executable by the processor to perform operations including identifying hardware components installed on a device prior to installing an operating system. The operations include determining a level for firmware installed on one or more hardware components of the identified hardware components. The operations include determining a level for a device driver available to the operating system for communicating with the hardware component. The operations include in response to determining that the available device driver level is not compliant with the firmware level for the hardware component, dynamically retrieving, from a repository of device drivers, a device driver that has a level that is compliant with the firmware level. The operations include installing the compliant device driver on the device during installation of the operating system.

### FIELD

The subject matter disclosed herein relates to device drivers and more particularly relates to dynamic driver selection based on firmware for a hardware component.

### BACKGROUND

In operating systems and hypervisors, it may be common to have a dependency between the firmware installed on the hardware and the device drivers in the operating systems/hypervisors. The life cycle of hardware and software may become misaligned, resulting in operating system/hypervisor releases that have an out-of-date driver. This may cause the hardware to be unusable to the operating system/hypervisor until the driver is updated, or at least restrict available features to a simple subset of what the hardware can provide when a matched firmware and driver pairing is determined.

### BRIEF SUMMARY

An apparatus, for dynamic driver selection based on firmware for a hardware component is disclosed. A method and computer program product also perform the functions of the apparatus. The apparatus includes a processor and a memory that stores program code configured to be executable by the processor to perform operations. The operations include identifying hardware components installed on a device prior to installing an operating system on the device. The operations include determining a level for firmware installed on one or more hardware components of the identified hardware components. The operations include determining a level for a device driver available to the operating system for communicating with the hardware component. The operations include, in response to determining that the available device driver level is not compliant with the firmware level for the hardware component, dynamically retrieving, from a repository of device drivers, a device driver that has a level that is compliant with the firmware level. The operations include installing the compliant device driver on the device during installation of the operating system.

A method for dynamic driver selection based on firmware for a hardware component includes identifying, by a processor, hardware components installed on a device prior to installing an operating system on the device. For one or more hardware components of the identified hardware components, the method includes determining a level for firmware installed on the hardware component and determining a level for a device driver available to the operating system for communicating with the hardware component. The method includes, in response to determining that the available device driver level is not compliant with the firmware level for the hardware component, dynamically retrieving, from a repository of device drivers, a device driver that has a level that is compliant with the firmware level, and includes installing the compliant device driver on the device during installation of the operating system.

A program product for dynamic driver selection based on firmware for a hardware component includes a computer readable storage medium and program code. The program code is configured to be executable by a processor to perform operations. The operations include identifying hardware components installed on a device prior to installing an operating system on the device. For one or more hardware components of the identified hardware components, the operations include determining a level for firmware installed on the hardware component, and the operations include determining a level for a device driver available to the operating system for, communicating with the hardware component. The operations include, in response to determining that the available device driver level is not compliant with the firmware level for the hardware component, dynamically retrieving, from a repository of device drivers, a device driver that has a level that is compliant with the firmware level, and include installing the compliant device driver on the device during installation of the operating system.

### BRIEF DESCRIPTION OF THE DRAWINGS

A more particular description of the embodiments briefly described above will be rendered by reference to specific embodiments that are illustrated in the appended drawings, Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of a system for dynamic driver selection based on firmware for a hardware component;

FIG. 1B is a schematic block diagram illustrating another embodiment of a system for dynamic driver selection based on firmware for a hardware component;

FIG. 2 is a schematic block diagram illustrating one embodiment of an apparatus for dynamic driver selection based on firmware for a hardware component;

FIG. 3 is a schematic block diagram illustrating another embodiment of an apparatus for dynamic driver selection based on firmware for a hardware component;

FIG. 4 is a schematic flow chart diagram illustrating one embodiment of a method for dynamic driver selection based on firmware for a hardware component; and

FIG. 5 is a schematic flow chart diagram illustrating one embodiment of another method for dynamic driver selection based on firmware for a hardware component.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or “Flash memory”), a portable compact disc read-only memory (“CD-ROM”), an optical storage device, a magnetic storage device, or any suitable combination of the foregoing. In the context of this document, a computer readable storage medium may be, any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc, to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations, of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible, implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

An apparatus for dynamic driver selection based on firmware for a hardware component is disclosed. A method and computer program product also perform the functions of the apparatus. The apparatus includes a processor and a memory that stores program code configured to be executable by the processor to perform operations. The operations include identifying hardware components installed on a device prior to installing an operating system on the device. The operations include determining a level for firmware installed on one or more hardware components of the identified hardware component. The operations include determining a level for a device driver available to the operating system for, communicating with the hardware component. The operations include, in response to determining that the available device driver level is not compliant with the firmware level for the hardware component, dynamically retrieving, from a repository of device drivers, a device driver that has a level that is compliant with the firmware level. The operations include installing the compliant device driver on the device during installation of the operating system.

In one embodiment, the operations include dynamically retrieving the device driver for the hardware component at a point during installation of the operating system when device drivers are installed. In certain embodiments, the operations include dynamically determining the firmware level for the hardware component during installation of the operating system. In some embodiments, the operating system that is installed on the device includes a virtual machine running on a hypervisor. The hypervisor, in some embodiments, is configured to dynamically install the compliant device driver retrieved from the device driver repository for the one or more hardware components during installation of the virtual machine. In some embodiments, the operations include, in response to detecting that the device driver repository is inaccessible, installing a default device driver for the one or more hardware components of the device that is compliant with the firmware for the hardware components.

In one embodiment, the operations include, in response to determining that the device driver repository does not include a compliant device driver for the hardware component, installing a generic device driver for the hardware component that is provided with the operating system. The operating system may include a plurality of generic device drivers for the hardware components. In some embodiments, the processor and the memory storing the program code is in a management server that is external to, but communicatively coupled to, the device where the operating system is being installed.

In one embodiment, the repository of device drivers is located locally on the management server and/or on a cloud device that is remote to, but communicatively coupled to, the management server. In further embodiments, the operations include periodically auditing the device to identify the hardware components of the device and to determine the firmware levels for the firmware of the one or more hardware components and inventorying information about the identified hardware components and the determined firmware levels for the firmware of the one or more hardware components for reference when an operating system is installed on the device.

In certain embodiments, the operations include maintaining a mapping of the firmware level for the one or more hardware components to device drivers that are compatible with the firmware level for the one or more hardware components based on the inventoried information. In some embodiments, the operations include selecting a device driver from the device driver repository that is compliant with the firmware level for the one or more hardware components based on one or more characteristics of the firmware. The one or more characteristics of the firmware may include a firmware version, a firmware date, a license key requirement for the firmware, and/or one or more optional functions of the firmware.

In some embodiments, the one or more optional functions of the firmware are enabled based on whether a license key is required and available to the selected device driver to enable the one or more optional functions. In certain embodiments, the one or more firmware characteristics include one or more functions for one or more auxiliary hardware components that are controlled by the hardware component where the firmware is installed. The one or more functions may be enabled in response to the selected device driver being compatible with the one or more functions of the one or more auxiliary hardware components. In further embodiments, the operations include periodically checking for updates for the device drivers in the device driver repository, receiving available updates for the device drivers in the device driver repository, and updating the device drivers in the device driver repository with the received device driver updates.

A method for dynamic driver selection based on firmware for a hardware component includes identifying, by a processor, hardware components installed on a device prior to installing an operating system on the device. For one or more hardware components of the identified hardware components, the method includes determining a level for firmware installed on the hardware component and determining a level for a device driver available to the operating system for communicating with the hardware component. The method includes, in response to determining that the available device driver level is not compliant with the firmware level for the hardware component, dynamically retrieving, from a repository of device drivers, a device driver that has a level that is compliant with the firmware level, and includes installing the compliant device driver on the device during installation of the operating system.

In some embodiments, the method includes dynamically retrieving the device driver for the hardware component at a point during, installation of the operating system when device drivers are installed. In certain embodiments, the method includes dynamically determining the firmware level for the hardware component during installation of the operating system.

In some embodiments, the operating system that is installed on the device includes a virtual machine running on a hypervisor. The hypervisor may be configured to dynamically install the compliant device driver retrieved from the device driver repository for the one or more hardware components during installation of the virtual machine. In certain embodiments, the method includes, in response to determining that the device driver repository does not include a compliant device driver for the hardware component, installing a generic device driver for the hardware component that is provided with the operating system. The operating system may include a plurality of generic device drivers for the hardware components.

A program product for dynamic driver selection based on firmware for a hardware component includes a computer readable storage medium and program code. The program code is configured to be executable by a processor to perform operations. The operations include identifying hardware components installed on a device prior to installing, an operating, system on the device. For one or more hardware components of the identified hardware components, the operations include determining a level for firmware installed on the hardware component, and the operations include determining a level for a device driver available to the operating system for communicating with the hardware component. The operations include, in response to determining that the available device driver level is not compliant with the firmware level for the hardware component, dynamically retrieving, from a repository of device drivers, a device driver that has a level that is compliant with the firmware level, and include installing the compliant device driver on the device during installation of the operating syste.

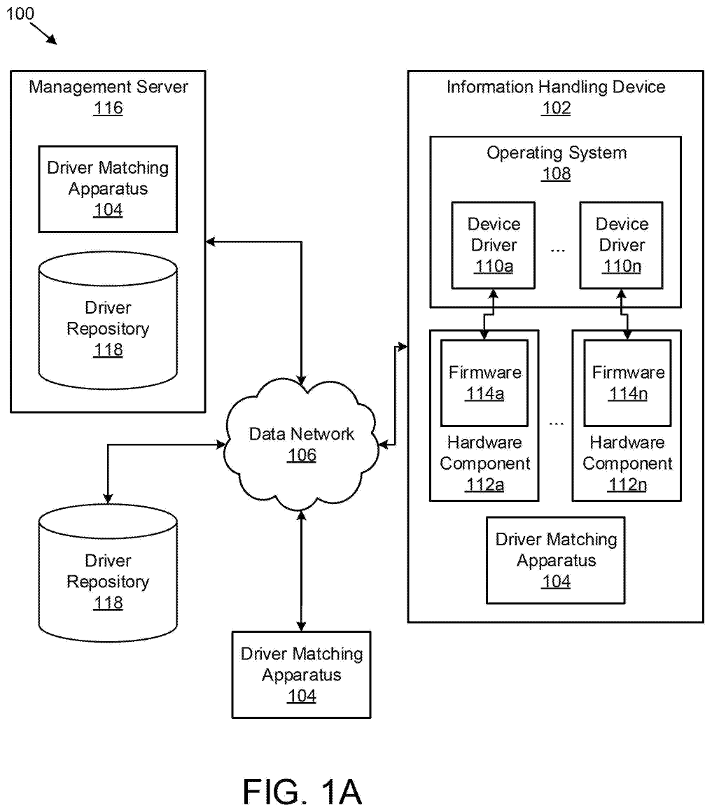

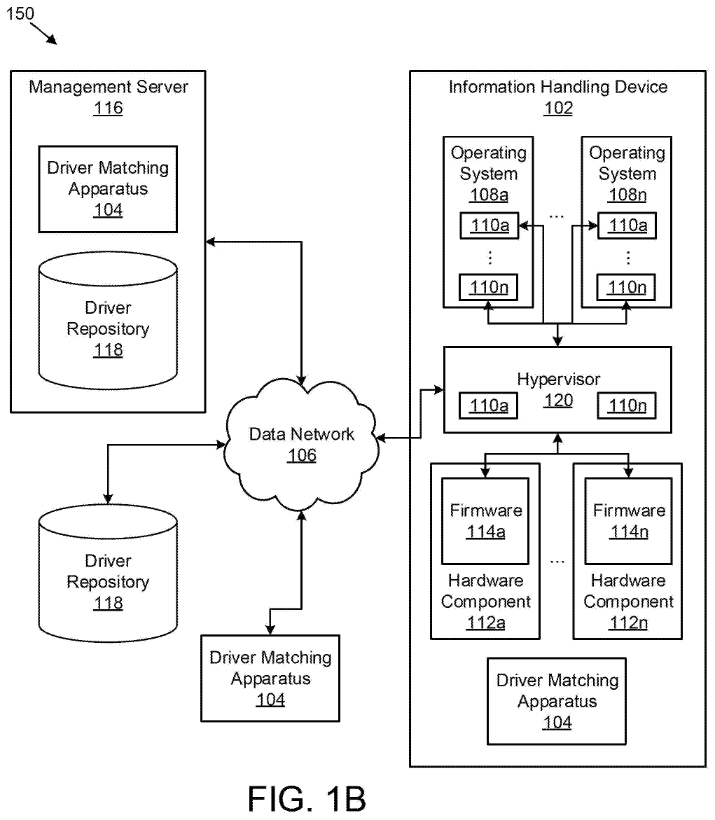

FIG. 1A depicts one embodiment of a system 100 for dynamic driver selection based on firmware for a hardware component. In one embodiment, the system 100 includes an information handling device 102. The information handling device 102 may include one or more of a desktop computer, a laptop computer, a mobile device, a tablet computer, a smart phone, a set-top box, a gaming console, a smart TV, a smart watch, a fitness band, an optical head-mounted display (e.g., a virtual reality headset, smart glasses, or the like), an HDMI or other electronic display dongle, a personal digital assistant, and/or another computing device. The information handling device 102 includes a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium.

In one embodiment, the information the information handling device 102 includes an operating system 108. An operating system 108, as used herein, may refer to system software that manages computer hardware, software resources, and provides common services for computer programs. For hardware functions such as input and output and memory allocation, the operating system 108 may act as an intermediary between programs and hardware components 112a-n (collectively 112). Examples may include Microsoft Windows®, Apple OSX®, Linux®, or mobile operating systems such as iOS® and Android®.

The hardware components 112 may include various hardware elements of the information handling device 102 that are configured to perform different tasks, functions, or the like. Examples may include network cards, sound cards, graphics cards, storage devices (including volatile and non-volatile memory devices), and/or the like. The hardware components 112 may include firmware 114, which, as used herein, includes software, programs, and/or executable code that provides low-level control of the functions of a hardware component 112. There may be different versions or levels of a firmware 114 for a hardware component 112. For example, when a network card ships or is sold with a system, the manufacturer may have installed firmware version A on the network card. Over time, the manufacturer may release updates to the firmware 114 such as version B six months and then version C six months after that. However, the network card may not have received the updated versions of the firmware 114, may not have the most up-to-date version of the firmware 114 installed, or the like.

The operating system 108, in one embodiment, communicates with and controls the hardware components 112 using device drivers 110a-n (collectively 110). The device drivers 110, as used herein, are software, programs, and/or executable code that the operating system 108 executes to interface with a hardware component 112, and in particular with the firmware 114 of a hardware component 112, to operate or control the functions of the hardware component 112. Similar to firmware 114, there may be different versions or levels of a device driver 110 for a hardware component 112 depending on the version or level that is installed in the operating system 108.

In one embodiment, the driver matching apparatus 104 is configured to dynamically determine a level or version of firmware 114 that is installed on one or more hardware components 112 in an information handling device 102, dynamically determine a level or version of device drivers 110 that interface with the firmware 114 of the hardware components 112, determine whether the level of firmware 114 of a hardware component 112 and the level of a corresponding device driver 110 are compliant, and if not, dynamically retrieving and installing a device driver 110 that has a level that is compliant with a level of the firmware 114 of the hardware component 112. In this manner, the driver matching apparatus 104 ensures that a device driver 110 is compliant with the firmware 114 of a corresponding hardware component 112, and if not, dynamically locates, accesses, retrieves, and installs a compliant device driver 110, which may occur during installation of the operating system 108.

The driver matching apparatus 104 improves upon conventional driver installation solutions by providing a dynamic, run-time solution to select a device driver 110 that is compliant with a firmware 114 of a hardware component 112 during installing of an operating system 108. Conventional systems, for, instance, may include a bare minimum functionality driver that is guaranteed to work against all known firmware is used to bootstrap the system 100. After the install is complete, a follow-up task updates the driver to the right level to match the firmware 114 discovered by the bare-minimum driver. This solution requires an extra system restart and additional coordination between the administrator and a driver repository.

In another conventional solution, drivers in the deployment image are updated periodically to a best-guess version that reflects a best fit for a majority of hardware in the deployment population. This is problematic in that it is speculative and will not work well in situations where hardware arrives with heterogeneous levels of firmware (for example, in service replacements where replacement stock is, older than current production by a significant margin). In other conventional solutions, deployments can utilize a cloned image of the installed operating system 108 with drivers, based upon a known good example within the field population. This process fails to be adaptable to differences in firmware and can result in a deployed image not being fully functional without maintenance on the underlying firmware.

The subject matter disclosed herein, however, improves upon the conventional methods by reducing the payload size of the operating system 108 because it only injects the device drivers 110 that are needed for the target hardware components 112, and not extra, unnecessary device drivers 110. Furthermore, the subject matter disclosed herein reduces the install time since the payload is optimized for the hardware it is being installed on and it has the flexibility to adapt to newer driver updates for existing hardware components 112 as well as adding drivers to support newer hardware components 112. Additionally, the subject matter disclosed herein can enact compliance policies that can cover driver installs to a wide swath of heterogenous hardware components 112, which may reduce the complexity of managing hardware permutations. Moreover, waiting until the operating system 108 is provisioned during runtime to couple the device driver 110 to the operating system 108 provides the management server 116 flexibility to update device drivers 110, as described below, whenever the driver repository 118 is updated instead of waiting for a newer operating system 108 build that preloads the device drivers 110.

In one embodiment, the information handling device 102 is communicatively coupled to a management server 116. The management server 116 may be a computing device that is configured to monitor and manage the information handling device 102, including the installation of hardware components 112, firmware 114, operating systems 108, and/or device drivers 110 on the information handling device 102. To facilitate the matching of a compliant device driver 110 with firmware 114 for a hardware component 112, the management server 116 may take inventory or stock of the hardware components 112 installed on the information handling device 102 and the versions or levels of the firmware 114 installed on the hardware components 112. The management server 116 may also maintain or manage a driver repository 118 of device drivers 110 for different operating systems 108, different firmware versions/levels, different hardware components 112, and/or the like. The driver repository 118 may be located in storage on the management server 116, may be located in a remote or cloud location that is accessible over the data network 106, and/or a combination of both. Similarly, the driver matching apparatus 104 may be located on the information handling device 102, on the management server 116, on the data network 106, and/or a combination of the foregoing.

In various embodiments, a driver matching apparatus 104 may be embodied as hardware, software, or some combination of hardware and software. In one embodiment, a driver matching apparatus 104 may include executable program code stored on a non-transitory computer readable storage medium for execution on a processor of an information handling device 102, a backend management server 116, or the like. For example, a driver matching apparatus 104 may be embodied as executable program code executing on an information handling device 102, a management server 116, a combination of one or more of the foregoing, or the like. In such an embodiment, the various modules that perform the operations of a driver matching apparatus 104, as described below, may be located on an information handling device 102, a management server 116, a combination of the two, and/or the like.

In various embodiments, a driver matching apparatus 104 may be embodied as a hardware appliance that can be installed or deployed on a management server 116, on an information handling device 102, or elsewhere on the data network 106, In certain embodiments, a driver matching apparatus 104 may include a hardware device such as a secure hardware dongle or other hardware appliance device (e.g., a set-top box, a network appliance, or the like) that attaches to another information handling device 102, such as a laptop computer, a server, a tablet computer, a smart phone, or the like, either by a wired connection (e.g., a USB connection) or a wireless connection (e.g., Bluetooth®, Wi-Fi®, near-field communication (“NFC”), or the like); that attaches to an electronic display device (e.g., a television or monitor using an HDMI port, a DisplayPort port, a Mini DisplayPort port, VGA port, DVI port, or the like); that operates substantially independently on a data network 106; or the like. A hardware appliance of an driver matching apparatus 104 may include a power interface, a wired and/or wireless network interface, a graphical interface (e.g., a graphics card and/or GPU with one or more display ports) that outputs to a display device, and/or a semiconductor integrated circuit device as described below, configured to perform the functions described herein with regard to an driver matching apparatus 104.

A driver matching, apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, a driver matching apparatus 104 may be mounted on a printed circuit board with one or more electrical lines or connections (e.g., to volatile memory, a non-volatile storage medium, a network interface, a peripheral device, a graphical/display interface. The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of a driver matching apparatus 104.

The semiconductor integrated circuit device or other hardware appliance of a driver matching apparatus 104, in certain embodiments, includes and/or is communicatively coupled to one or more volatile memory media, which may include but is not limited to: random access memory (“RAM”), dynamic RAM (“DRAM”), cache, or the like. In one embodiment, the semiconductor integrated circuit device or other hardware appliance of a driver matching apparatus 104 includes and/or is communicatively coupled to one or more non-volatile memory media, which may include but is not limited to: NAND flash memory, NOR flash memory, nano random access memory (“nano RAM” or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASFI7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

FIG. 1B depicts another embodiment of a system 150 for dynamic driver selection based on firmware for a hardware component 112. In one embodiment, the system 150 may be substantially similar to the system 100 described above with reference to FIG. 1A,

FIG. 1B depicts an information handling device 102 as a host machine that includes a hypervisor 120 for hosting a plurality of guest operating systems 108 in a virtual environment on the information handling device 102. As used herein, a hypervisor 120 may refer to software, programs, firmware, hardware, or executable code that is configured to create, run, and manage virtual machines, e.g., virtual instances of operating systems 108 and may include two or more cores. A virtual machine, as used herein, may refer to an emulation of a computer system, operating systems, applications, programs, or other executable code.

In certain embodiments, a guest operating system 108 may include its own set of device drivers 110 for interfacing with the firmware 114 of the underlying hardware components 112 of the information handling device 102. Furthermore, in some embodiments, the hypervisor 120 includes device drivers 110 for interfacing with the firmware 114 of the hardware components 112. Accordingly, the driver matching apparatus 104 is configured to determine whether the levels or versions of the device drivers 110 are compliant with the levels or versions of the firmware 114 of the hardware components 112, and if not, dynamically determines and installs a device driver 110 for a hardware component 112 that is compliant with the firmware 114 for the hardware component 112 during installation of the operating system 108 or hypervisor 120.

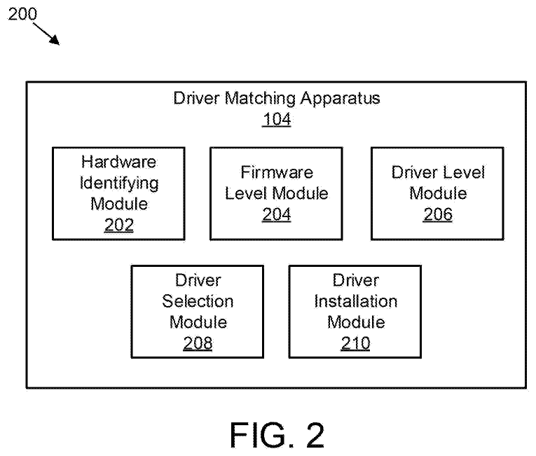

FIG. 2 depicts one embodiment of an apparatus 200 for dynamic driver selection based on firmware 114 for a hardware component 112. In one embodiment, the apparatus 200 includes an embodiment of a driver matching apparatus 104. The driver matching apparatus 104 includes one or more of a hardware identifying module 202, a firmware level module 204, a driver level module 206, a driver selection module 208, and a driver installation module 210, which are described in more detail below.

The hardware identifying module 202, in one embodiment, is configured to identify hardware components 112 that are installed on an information handling, device 102 (or simply “device 102”) prior to installing an operating system 108 on the device 102. The hardware identifying module 202 may identify hardware components 112 that are installed or deployed on a device 102 during installation of the operating system 108, For instance, the hardware identifying module 202 may scan a device 102 to determine various, hardware components 112 that are installed in the device 102 at a point during installation of an operating system 108 on the device 102 (e.g., by querying BIOS or other low-level firmware 114 for the device 102).

The hardware identifying module 202, in certain embodiments, collects, stores, or the like information about the hardware components 112 such as a serial number, product number, manufacturer information, product model/version, current firmware version/level, license requirements, and/or the like. The hardware identifying module 202 may store the hardware component information locally in a data store on the device 102 where the operating system 108 is being installed, in a data repository on the management server 116, and/or in another remote or cloud location.

In one embodiment, the hardware identifying module 202 uses previously collected hardware information for hardware components 112 installed on the device 102 to determine whether there are any differences or changes with the hardware components 112 or any new hardware components 112 that have been installed in the device 102 during installation of an operating system 108 on the device 102. In other words, instead of performing a full scan of hardware components 112 installed in the device 102, the hardware identifying module 202 identifies new, removed, or modified hardware components 112 installed in the device 102 since the most recent scan of the device 102 and collects information about the new or modified hardware components 112.

The firmware level module 204, in one embodiment, is configured to determine a level for firmware 114 installed on one or more hardware components 112 of the device 102. The level of firmware 114, as used herein, may refer to a firmware version that is installed on a hardware component 112. The firmware level module 204 may use the information that the hardware identifying module 202 collects to analyze or otherwise determine a firmware level for the firmware 114 installed on a hardware device 102. In further embodiments, the firmware level module 204 dynamically determines a firmware level for firmware 114 of a hardware component 112 during installation of an operating system 108 on the device 102.

In some embodiments, the firmware level module 204 uses previously stored firmware level information for a hardware component 112 to determine the firmware level of firmware 114 for the hardware component 112. For instance, if the firmware information for a hardware component 112 was, previously determined and stored, and the hardware identifying module 202 determines that the hardware component 112 is still installed in the device 102 and has not changed since that last hardware scan of the device 102, then the firmware level module 204 may use previously collected firmware information for the hardware component 112 to determine the firmware level for the firmware 114 installed on the hardware component 112.

The driver level module 206, in one embodiment, is configured to determine a level for a device driver 110 available to the operating system 108 for communicating with the hardware component 112. As used herein, the level for a device driver 110 may be a version number for the device driver 110. A device driver 110, in certain embodiments, may be configured, programmed, or otherwise designed for a particular level or version of firmware 114 for a hardware component 112. While certain device drivers 110 may be generic enough to work with various levels or versions of firmware 114, such a device driver 110 may not be the best fit for the firmware 114, may not be configured to utilize various features or functions of the hardware component 112 that firmware 114 of a certain level provides (e.g., may not be configured to interface with the firmware interface, function calls, API calls, or the like), and/or the like.

In one embodiment, the driver level module 206 determines which device drivers 110 are available to the operating system 108 when the operating system 108 is being installed on the device 102. The operating system 108, for instance, may have a library of device drivers 110 that are default or generic and configured to work with various different hardware components 112 so that the operating system 108 can be installed on various devices 102 that have different hardware configurations. The driver level module 206 may determine the level or version of the device drivers 110 that the operating system 108 would install by default, which may be used to determine if the device driver levels are compliant, with the firmware 114 installed on the hardware components 112.

The driver selection module 208, in one embodiment, is configured to dynamically retrieve, from the driver repository 118, a device driver 110 that has a level that is compliant with the firmware level for firmware 114 of a hardware device 110 that corresponds to the device driver 110 in response to determining that the available device driver level is not compliant with the firmware level for the hardware component 112. As used herein, a compliant device driver 110 is a device driver 110 that is not only compatible with a hardware component 112 to control basic functions of the hardware component 112, but is also configured to utilize advanced or optional features of a hardware component 112, to more efficiently control the hardware component 112, and/or the like, as it communicates with the firmware 114 for the hardware component 112. Such a device driver 110 may be updated to a most up-to-date version of the device driver 110 prior to installing the device driver 110 on the device 102 during installation of the operating system 108.

In response to determining that the device driver 110 for a hardware component 112 has a level that is not compliant with a firmware level of firmware 114 installed on the hardware component 112, the driver selection module 208 dynamically, e.g., during operating system install, accesses, queries, or the like the driver repository 118 to retrieve a device driver 110 that is compliant with the firmware level of the firmware 114 installed on the hardware component 112 associated with the device driver 110. In certain embodiments, the driver selection module 208 accesses the driver repository 118 at a point during operating system installation when the device drivers 110 are being installed for the hardware components 112 installed in the device 102.

In one embodiment, the driver selection module 208 selects a device driver 110 from the device driver repository 118 that is compliant with the firmware level for the firmware 114 for one or more of the hardware components 112 in the device 102 based on one or more characteristics of the firmware 114. In certain embodiments, the one or more characteristics of the firmware 114 include a firmware version, a firmware date (e.g., a release date, an update date, or the like), a license key requirement for the firmware 114 (e.g., whether the firmware 114 requires license keys to access different features/functions of the firmware 114), one or more optional functions of the firmware 114, and/or the like.

In one embodiment, if a firmware 114 has one or more optional features, such as different features or functions for a hardware component 112, the one or more optional functions of the firmware 114 may be enabled using a license key. For instance, a non-volatile storage device may have additional storage features such as data deduplication, data defragmentation, data encryption, and/or the like that are only available with the use of a license key. In such an embodiment, the driver selection module 208 may select a device driver 110 from the driver repository 118 if the device driver 110 has access to a license key to enable the one or more optional functions/features of the firmware 114/hardware component 112.

In further embodiments, the firmware characteristics further include one or more functions for one or more auxiliary hardware components 112 that are controlled by the hardware component 112 where the firmware 114 is installed. For example, a non-volatile storage device may act as a master device for one or more other non-volatile storage devices that are used in conjunction with the master device, e.g., in a RAID configuration. In such an embodiment, the driver selection module 208 may select a device driver 110 that is configured to enable and utilize the functions of the auxiliary hardware components 112 (e.g., the RAID devices).

In one embodiment, the driver selection module 208 selects a compliant generic or default device driver 110 for the hardware component 112 in response to detecting or determining that the device driver repository 118 is inaccessible. For instance, if a network connection to the driver repository 118 is unavailable, the driver selection module 208 may select a compliant generic or default device driver 110 that is available to or packaged with the operating system 108 that is being installed so that installation of the operating system 108 is not paused or stopped to wait to establish a connection to the driver repository 118.

In one embodiment, the driver selection module 208 selects a compliant generic or default device driver 110 in response to determining that the device driver repository 118 does not include or store a device driver 110 that is compliant with a firmware level of the firmware 114 for the hardware component 112. In such an embodiment, the operating system 108 may be packaged with a plurality of generic or default device drivers 110 that are functional enough to communicate with the firmware 114 for a hardware component 112 to control basic features/functions of the hardware component 112.

In one embodiment, the driver installation module 210 is configured to install the compliant device driver 110 on the device 102 during installation of the operating system 108. The compliant device driver 110 may be installed directly as part of the operating system installation so that it is locally available to the operating system 108. In some embodiments, as described above, the operating system 108 that is installed on the device 102 includes a virtual machine running on a hypervisor 120 such that the hypervisor 120 is configured to dynamically install the compliant device driver 110 that is retrieved from the device driver repository 118 (or a default/generic device driver 110 if a different device driver 110 is not available from the driver repository 118) at the hypervisor 120 and/or at the virtual machine for one or more of the hardware components 112 during installation of the virtual machine.

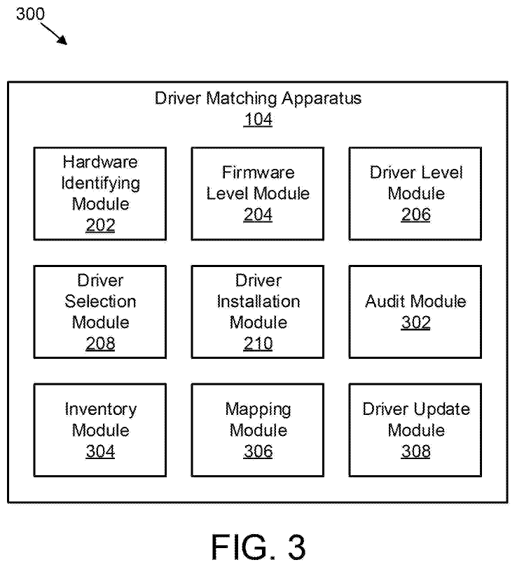

FIG. 3 depicts one embodiment of an apparatus 300 for dynamic driver selection based on firmware 114 for a hardware component 112. In one embodiment, the apparatus 300 includes an embodiment of a driver matching apparatus 104. The driver matching apparatus 104 includes one or more of a hardware identifying module 202, a firmware level module 204, a driver level module 206, a driver selection module 208, and a driver installation module 210, which may be substantially similar to the hardware identifying module 202, the firmware level module 204, the driver level module 206, the driver selection module 208, and the driver installation module 210 described above with reference to FIG. 2. In further embodiments, the driver matching apparatus 104 includes one or more of an audit module 302, an, inventory module 304, a mapping module 306, and a driver update module 308, which are described in more detail below.

The audit module 302, in one embodiment, is configured to periodically audit the device 102 to identify the hardware components 112 of the device 102 and to determine the firmware levels for the firmware 114 of one or more of the hardware components 112. The audit module 302, for example, may take inventory of the device 102 to determine or identify the hardware components 112 installed in the device 102, including the various characteristics of the hardware components 112, described above. The audit module 302 may perform a hardware scan of the device 102 every hour, every day, every week, every month, every six months, or the like, and/or when a hardware configuration of the device 102 changes, e.g., when a new hardware component 112 is added, when a hardware component 112 is removed, when a hardware component 112 is modified, and/or the like.

The inventory module 304, in one embodiment, is configured to inventory information about the identified hardware components 112 and the determined firmware levels for the firmware 114 of one or more of the identified hardware components 112 for reference when an operating system 108 is installed on the device 102 in response to the audit that the audit module 302 performs. The inventory module 304 may add, update, remove, or the like information from a database, data store, table, map, or the like that contains information for one or more of the hardware components 112 installed on, the device 102. The information may include hardware component 112 information such as a manufacturer, a serial number, a product number, a model number, a year of manufacture, a default firmware level for the firmware 114 of the hardware component 112, a firmware level for a currently installed firmware 114 for the hardware component 112, and/or the like. The information may be used to identify a compliant a device driver 110 for the hardware component 112 during installation of the operating system 108.

The mapping module 306, in one embodiment, is configured to maintain a mapping of the firmware level for the firmware 114 for one or more of the hardware components 112 to device drivers 110 that are compatible with the firmware level for the firmware 114 for one or more of the hardware components 112 based on the inventoried information. For instance, the mapping module 306 may maintain a mapping of compliant device drivers 110 that are available in the driver repository 118 to hardware components 112 that are installed in the device 102, and more particularly, to firmware 114 of the hardware components 112 that the device drivers 110 are compliant with. In this manner, during installation of an operating system 108 on the device 102, the mapping may be referenced to easily determine which device drivers 110 are compliant with the firmware 114 that is installed on a hardware component 112 instead of scanning through the driver repository 118 to locate a compliant device driver 110.

The driver update module 308, in one embodiment, is configured to periodically check for updates for the device drivers 110 in the device driver repository 118. For example, the driver update module 308 may periodically check a manufacturer's website for available downloads/updates for a hardware component's firmware 114. The driver update module 308, in further embodiments, the driver update module 308 receives or downloads available updates for the device drivers 110 in the device driver repository 118 and updates the device drivers 110 in the device driver repository, 118 with the received/downloaded device driver updates. In this manner, the available device drivers 110 in the driver repository 118 are kept up-to-date so that the device drivers 110 do not need to be updated during or after installation of the operating system 108 on the device 102.

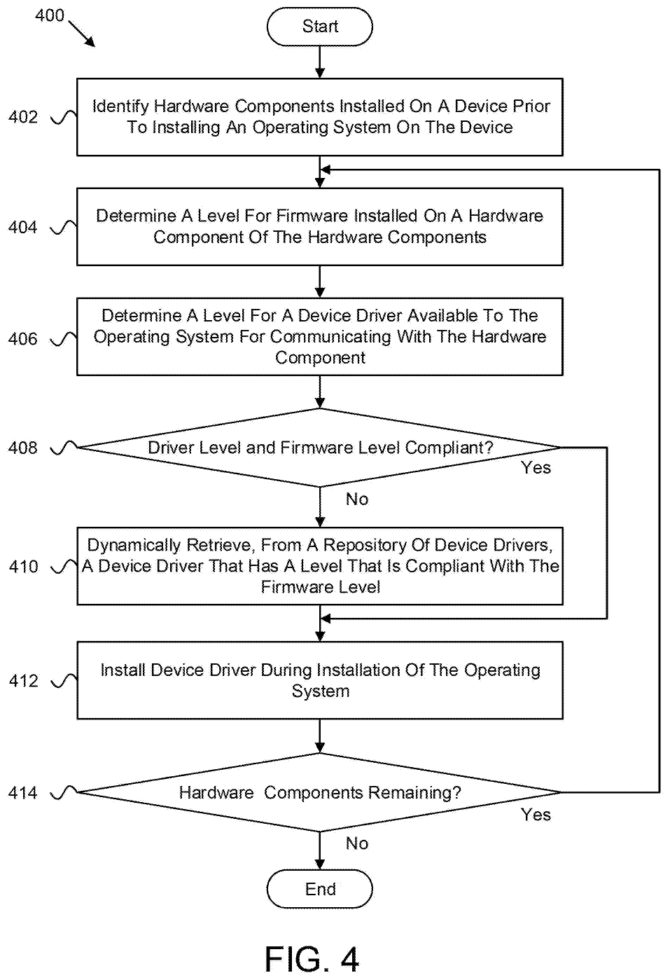

FIG. 4 depicts a schematic flow chart diagram illustrating one embodiment of a method 400 for dynamic driver selection based on firmware 114 for a hardware component 112. In one embodiment, the method 400 begins and identifies 402 hardware components 112 that are installed on a device 102 prior to installing an operating system 108 on the device 102. In further embodiments, the method 400 determines 404 a level for firmware 114 installed on one or more hardware components 112 in the device 102.

In certain embodiments, the method 400 determines 406 a level for a device driver 110 available to the operating system 108 for communicating with the hardware component 112. The method 400, in further embodiments, determines 408 whether the device driver level and the firmware level are compliant. If not, the method 400 may dynamically retrieve 410, from a driver repository 118, a device driver 110 that has a level that is compliant with the firmware level of the firmware 114 for the hardware component 112.

The method 400, in one embodiment, installs 412 the compliant device driver 110 on the device 102 during installation of the operating system 108. The method 400, in certain embodiments, determines 414 whether there are additional hardware components 112 to determine device drivers 110 for during installation of the operating system 108. If so, the method 400 continues to determine 404 the firmware level of the firmware 114 installed on the next hardware component 112. Otherwise, the method 400 ends. In certain embodiments, the hardware identifying module 202, the firmware level module 204, the driver level module 206, the driver selection module 208, and/or the driver installation module 210 perform the various steps of the method 400.

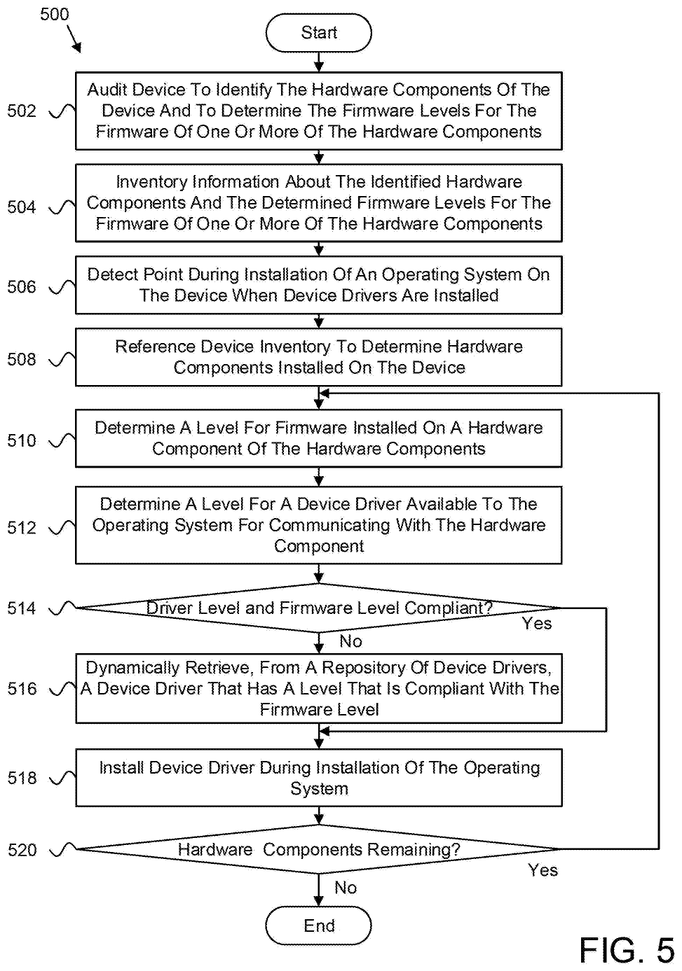

FIG. 5 depicts a schematic flow chart diagram illustrating one embodiment of a method 500 for dynamic driver selection based on firmware 114 for a hardware component 112. In one embodiment, the method 500 begins and audits 502 the device 102 where an operating system 108 will be installed to identify the hardware components 112 of the device 102 and to determine the firmware levels for the firmware 114 of one or more of the hardware components 112.

The method 500, in further embodiments, inventories 504 information about the identified hardware components 112 and the determined firmware levels for the firmware 114 of one or more of the hardware components 112. In certain embodiments, the method 500 detects 506 a point during installation of an operating system 108 on the device 102 when device drivers 110 are installed. The method 500, in one embodiment, references 508 the device inventory to determine which hardware components 112 are installed on the device 102.

The method 500, in certain embodiments, determines 510 a level for firmware 114 installed on one or more of the hardware components 112 in the device 102. The method 500, in further embodiments, determines 512 a level for a device driver 110 that is available to the operating system 108, e.g., packaged with the operating system 108, for communicating with the hardware component 112. The method 500, in one embodiment, determines 514 whether the device driver level and the firmware level for the firmware 114 of the hardware component 112 are compliant.

If not, the method 500 dynamically retrieves 516, from a driver repository 118, a device driver 110 that has a level that is compliant with the firmware level of firmware 114 for a hardware component 112. The method 500, in certain embodiments, installs 518 the compliant device driver 110 on the device 102 during installation of the operating system 108 and determines 520 whether there are additional hardware components 112 to determine device drivers 110 for during installation of the operating system 108.

If so, the method 500 continues to determine 510 the firmware level of the firmware 114 installed on the next hardware component 112. Otherwise, the method 500 ends. In certain embodiments, the hardware identifying module 202, the firmware level module 204, the driver level module 206, the driver selection module 208, the driver installation module 210, the audit module 302, the inventory module 304, the mapping module 306, and/or the driver update module 308 perform the various steps of the method 500.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor;
a memory storing program code configured to be executable by the processor to perform operations comprising:
identifying hardware components installed on a device prior to installing an operating system on the device; and
for one or more hardware components of the identified hardware components:
determining a level for firmware installed on the hardware component;
determining a level for a device driver available to the operating system for communicating with the hardware component;
in response to determining that the available device driver level is not compliant with the firmware level for the hardware component, dynamically retrieving, from a repository of device drivers, a device driver that has a level that is compliant with the firmware level; and
installing the compliant device driver on the device during installation of the operating system.

2. The apparatus of claim 1, wherein the operations further comprise dynamically retrieving the device driver for the hardware component at a point during installation of the operating system when device drivers are installed.

3. The apparatus of claim 1, wherein the operations further comprise dynamically determining the firmware level for the hardware component during installation of the operating system.

4. The apparatus of claim 1, wherein the operating system that is installed on the device comprises a virtual machine running on a hypervisor, and wherein the hypervisor is configured to dynamically install the compliant device driver retrieved from the device driver repository for the one or more hardware components during installation of the virtual machine.

5. The apparatus of claim 1, wherein the operations further comprise, in response to detecting that the device driver repository is inaccessible, installing a default device driver for the one or more hardware components of the device that is compliant with the firmware for the hardware components.

6. The apparatus of claim 1, wherein the operations further comprise, in response to determining that the device driver repository does not include a compliant device driver for the hardware component, installing a generic device driver for the hardware component that is provided with the operating system, the operating system comprising a plurality of generic device drivers for the hardware components.

7. The apparatus of claim 1, wherein the processor and the memory storing the program code is in a management server that is external to, but communicatively coupled to, the device where the operating system is being installed.

8. The apparatus of claim 7, wherein the repository of device drivers is located locally on the management server and/or on a cloud device that is remote to, but communicatively coupled to, the management server.

9. The apparatus of claim 1, wherein the operations further comprise:
periodically auditing the device to identify the hardware components of the device and to determine the firmware levels for the firmware of the one or more hardware components; and
inventorying information about the identified hardware components and the determined firmware levels for the firmware of the one or more hardware components for reference when an operating system is installed on the device.

10. The apparatus of claim 9, wherein the operations further comprise maintaining a mapping of the firmware level for the one or more hardware components to device drivers that are compatible with the firmware level for the one or more hardware components based on the inventoried information.

11. The apparatus of claim 1, wherein the operations further comprise selecting a device driver from the device driver repository that is compliant with the firmware level for the one or more hardware components based on one or more characteristics of the firmware, the one or more characteristics of the firmware comprising a firmware version, a firmware date, a license key requirement for the firmware, and/or one or more optional functions of the firmware.

12. The apparatus of claim 11, wherein the one or more optional functions of the firmware are enabled based on whether a license key is required and available to the selected device driver to enable the one or more optional functions.

13. The apparatus of claim 11, wherein the one or more firmware characteristics further comprise one or more functions for one or more auxiliary hardware components that are controlled by the hardware component: where the firmware is installed, the one or more functions enabled in response to the selected device driver being compatible with the one or more functions of the one or more auxiliary hardware components.

14. The apparatus of claim 1, wherein the operations further comprise:
periodically checking for updates for the device drivers in the device driver repository;
receiving available updates for the device drivers in the device driver repository; and
updating the device drivers in the device driver repository with the received device driver updates.

15. A method comprising:
identifying, by a processor, hardware components installed on a device prior to installing an operating system on the device; and
for one or more hardware components of the identified hardware components:
determining, a level for firmware installed on the hardware component;
determining a level for a device driver available to the operating system for communicating with the hardware component;
in response to determining that the available device driver level is not compliant with the firmware level for the hardware component, dynamically retrieving, from a repository of device drivers, a device driver that has a level that is compliant with the firmware level; and
installing the compliant device driver on the device during installation of the operating system.

16. The method of claim 15, further comprising dynamically retrieving the device driver for the hardware component at a point during installation of the operating system when device drivers are installed.

17. The method of claim 15, further comprising dynamically determining the firmware level for the hardware component during installation of the operating system.

18. The method of claim 15, wherein the operating system that is installed on the device comprises a virtual machine running on a hypervisor, and wherein the hypervisor is configured to dynamically install the compliant device driver retrieved from the device driver repository for the one or more hardware components during installation of the virtual machine.

19. The method of claim 15, further comprising, in response to determining that the device driver repository does not include a compliant device driver for the hardware component, installing a generic device driver for the hardware component that is provided with the operating, system, the operating system comprising a plurality of generic device drivers for the hardware components.

20. A program product comprising a computer readable storage medium and program code, the program code being configured to be executable by a processor to perform operations comprising:
identifying hardware components installed on a device prior to installing an operating system on the device; and
for one or more hardware components of the identified hard are components:
determining a level for firmware installed on the hardware component;
determining a level for a device driver available to the operating, system for communicating with the hardware component;
in response to determining that the available device driver level is not compliant with the firmware level for the hardware component, dynamically retrieving, from a repository of device drivers, a device driver that has a level that is compliant with the firmware level; and
installing the compliant device driver on the device during installation of the operating system.
